(19) United States
(12) Patent Application Publication
(10) Pub. No.: US 2011/0199582 A1
(43) Pub. Date: Aug. 18, 2011

(54) Light Source Unit, Optical Scanning Display, and Retinal Scanning Display

(75) Inventors: Yuichiro KURIKI, Nagoya-shi (JP); Mitsugi TANAKA, Nagoya-shi (JP)

(73) Assignee: BROTHER KOGYO KABUSHIKI KAISHA, Nagoya-shi (JP)

(21) Appl. No.: 13/023,966

(22) Filed: Feb. 9, 2011

(30) Foreign Application Priority Data
Feb. 12, 2010 (JP) 2010-029304

(51) Int. Cl. G03B 21/14; F21V 8/00; H05B 37/02

(52) U.S. Cl. 353/31; 362/554; 315/158; 315/152

(57) ABSTRACT

A light source unit includes an optical coupler, light sources, a light output portion, a light sensor, and a controller. The optical coupler is formed by joining intermediate portions of plural optical fibers together and multiplexes lights, which have entered respective one ends of the optical fibers, in a coupling region where the intermediate portions of the optical fibers are joined together. The light sources emit light of different wavelengths that enter the respective one ends of the plural optical fibers. The light output portion is formed by the other end of one of the plural optical fibers and outputs the multiplexed lights. The light sensor detects light emerging from the other end of at least another one of the plural optical fibers.

### CROSS-REFERENCE TO RELATED APPLICATION

This Application claims priority from JP2010-029304, filed on Feb. 12, 2010, the content of which is hereby incorporated by reference.

### BACKGROUND OF THE DISCLOSURE

1. Field of the Disclosure

One or more aspects of the disclosure relate to a light source unit that transmits light from a light source through an optical fiber, an optical scanning display, and a retinal scanning display, each display including the light source unit.

2. Description of the Related Art

In a known optical scanning display, an image is formed by two-dimensionally scanning light with varying intensity corresponding to an image signal. As one practical example of the optical scanning display, there is a retinal scanning display for displaying an image by scanning the light and projecting the scanned light to at least one retina of a user.

As illustrated in FIG. 8, the retinal scanning display includes a light source unit 100 and a display unit 200. The light source unit 100 emits light under control of a controller 800. The display unit 200 two-dimensionally scans the light emitted from the light source unit 100 and projects the scanned light to at least one eye of the user.

The light source unit 100 includes a plurality of (e.g., three) optical fibers 300, 300 and 300 for a red light, a green light, and a blue light. The three optical fibers 300, 300 and 300 are joined together in their intermediate portions by the melt-drawing method, to thereby form an optical coupler. This optical coupler constitutes an RGB optical multiplexer module 400.

In the light source unit 100, visible lights of different wavelengths, such as the red light, the green light, and the blue light, are emitted from light sources 500R, 500G and 500B for the red light, the green light, and the blue light, respectively, and then enter the ends of the three optical fibers 300, 300 and 300. The visible lights of different wavelengths are multiplexed by the RGB optical multiplexer module 400. The multiplexed lights (i.e., a resulting multiplex light) are two-dimensionally scanned by the display unit 200 and finally enter an eye 600 of the user. In FIG. 8, reference numeral 110 denotes a casing of the light source unit 100, and 900 denotes a fiber spliced portion.

As illustrated in FIG. 9, the light source unit 100 further includes a terminator 310 that is disposed at each of the ends of two among the three optical fibers 300, 300 and 300 other than the remaining one optical fiber 300 (hereinafter referred to as an “output optical fiber”), which is used to transmit the multiplex light to the display unit 200. The terminator 310 prevents leakage of the light from the optical fiber 300 other than the output optical fiber through which the multiplex light is transmitted.

As illustrated in FIG. 8, the light source unit 100 still further includes, within a cabinet 510, a photodiode 700 for detecting the intensity of the light emitted from a laser device 520 in each of the light sources 500R, 500G, and 500B. The photodiode 700 is disposed on one side of the laser device 520 opposite to the other side where the beam is output toward the optical fiber 300.

In the retinal scanning display including the above-described light source unit 100, the controller 800 drives the laser device 520 in accordance with a drive signal corresponding to an image signal. The laser device 520 emits light with intensity corresponding to the image signal.

However, if an abnormality occurs in intensity of any of the lights emitted from the light sources 500R, 500G, and 500B, the intensity of the light entering the eye 600 of the user may be excessively increased.

For that reason, when the intensity of the light emitted from the laser device 520 exceeds a predetermined value, the controller 800 controls the laser device 520 such that the intensity of a laser beam output from the laser device 520 is held to be not larger than the predetermined value.

In the light source unit 100, however, the photodiode 700 is disposed within the housing 530, specifically within the cabinet 510, of each of the light sources 500R, 500G, and 500B. Accordingly, only an abnormality of the light intensity attributable to the laser device 520, which is also disposed within the cabinet 510, is detected in the light source unit 100. The photodiode 700 cannot detect, for example, abnormalities of the light intensity, which are attributable to the pigtail coupling efficiency in a connecting portion between the housing 530 of each of the light sources 500R, 500G, and 500B and the optical fiber 300 and to the coupling efficiency in the fiber slicing portion 900. Further, as a matter of course, an abnormality of the light intensity due to a failure of the photodiode 700 cannot be detected. Thus, the light source unit 100 currently used in the retinal scanning display still has room for improvement in detecting the abnormality of the light intensity.

One conceivable proposal for the improvement is to dispose a known light output controller at a position, for example, between an output end of the output optical fiber and the light source unit 100. With such a proposal, the light output controller can detect an abnormal intensity of light and attenuate the light.

However, when the above-described known light output controller is applied to the light source unit 100, an optical attenuator, an optical coupler, etc. are additionally required. An increase in size and cost of the light source unit is hence unavoidable.

A method of detecting an abnormal intensity of light, illustrated in FIG. 10, is conceivable as another solution. According to the method, a beam splitter 220 is disposed in an optical path 210 inside the display unit 200. Further, part of a light L1 emitted from the light source unit 100 is branched by the beam splitter 220 as a branched light L2. An intensity of the light L1 is controlled by detecting the branched light L2 with a display-unit side photodiode, i.e., a photodiode 700 disposed in the display unit 200.

However, the above-described method requires an increased number of components in the display unit 200. Because the display unit 200 of the retinal scanning display is mounted to a user's head, an increase in size and weight of the display unit 200 is not desired.

Further, because the light L1 is branched, a loss of the light intensity is increased. An output setting value for each of the light sources 500R, 500G, and 500B has to be increased in order to compensate for the loss of the light intensity. Consequently, power consumption and heat generation are increased.

### SUMMARY

An aspect of the disclosure is to provide a light source unit capable of more reliably detecting an abnormal intensity of emitted light while suppressing the power consumption and the heat generation without causing a loss of the light intensity, and to provide an optical scanning display and a retinal scanning display, each display including the light source unit.

According to one aspect of the disclosure, a light source unit includes an optical coupler, a light source, a light output portion, and a light sensor. The optical coupler is formed by joining intermediate portions of plural optical fibers together and multiplexes lights, which enters one end of each of the optical fibers, in a coupling region where the intermediate portions of the optical fibers are joined together. The light source emits lights of different wavelengths. Each of the lights enters the one end of each of the plural optical fibers. The light output portion is located on the other end of one of the plural optical fibers and outputs the multiplexed lights. The light sensor detects light emitted from the other end of at least another one of the plural optical fibers.

According to another aspect of the disclosure, an optical scanning display includes the above-mentioned light source unit, an optical scanner for two-dimensionally scanning the lights emitted from the light sources unit with intensities corresponding to an image signal, and a projector for projecting the lights scanned by the optical scanner to a projection target.

According to another aspect of the disclosure, a retinal scanning display includes the above-mentioned light source unit, an optical scanner for two-dimensionally scanning the lights emerging from the light source unit with intensities corresponding to an image signal, and a projector for projecting the lights scanned by the optical scanner to an eye of a user.

### BRIEF DESCRIPTION OF THE DRAWINGS

For a more complete understanding of the invention, the needs satisfied thereby, and the objects, features, and advantages thereof, reference now is made to the following description taken in connection with the accompanying drawings.

FIG. 1 is an explanatory view illustrating an external appearance of a retinal scanning display according to an embodiment;

FIG. 2 is an explanatory view illustrating electrical configuration and optical configuration of the retinal scanning display;

FIG. 3 is a schematic explanatory view illustrating a light source unit of the retinal scanning display;

FIG. 4A is an explanatory view of a light multiplexer module included in the light source unit;

FIG. 4B is an explanatory view illustrating a modification of the light multiplexer module;

FIG. 5 is an explanatory view of a light sensing means (light sensor) in the embodiment;

FIG. 6 is a flowchart illustrating a flow of a process of controlling an output of a light source, which is executed by a controller;

FIG. 7 is a schematic explanatory view of a retinal scanning display, including a light source unit, according to another embodiment;

FIG. 8 is a schematic explanatory view illustrating a light source unit of a usual retinal scanning display;

FIG. 9 is an explanatory view illustrating a state in use of a usual light multiplexer module; and

FIG. 10 is an explanatory view illustrating one example of usual light sensing means.

### DETAILED DESCRIPTION

An optical scanning display according to one embodiment of the present invention will be described below in sequence of the following captions with reference to the drawings. The drawings are referenced to explain technical features that can be employed in this disclosure. The configurations of displays and units, a flowchart of various processes, etc., which are illustrated in the drawings, are merely explanatory examples, and they should not be construed to limit this disclosure. The optical scanning display according to the embodiment is described as a head mounted display of the type mounted to a head of a user and further as a retinal scanning display (hereinafter abbreviated to an “RSD”) that enables the user to visually recognize an image by projecting light to an eye of the user.

It is noted that various connections are set forth between elements in the following description. It is noted that these connections in general and, unless specified otherwise, may be direct or indirect and that this specification is not intended to be limiting in this respect.

### 1. Retinal Scanning Display (RSD)

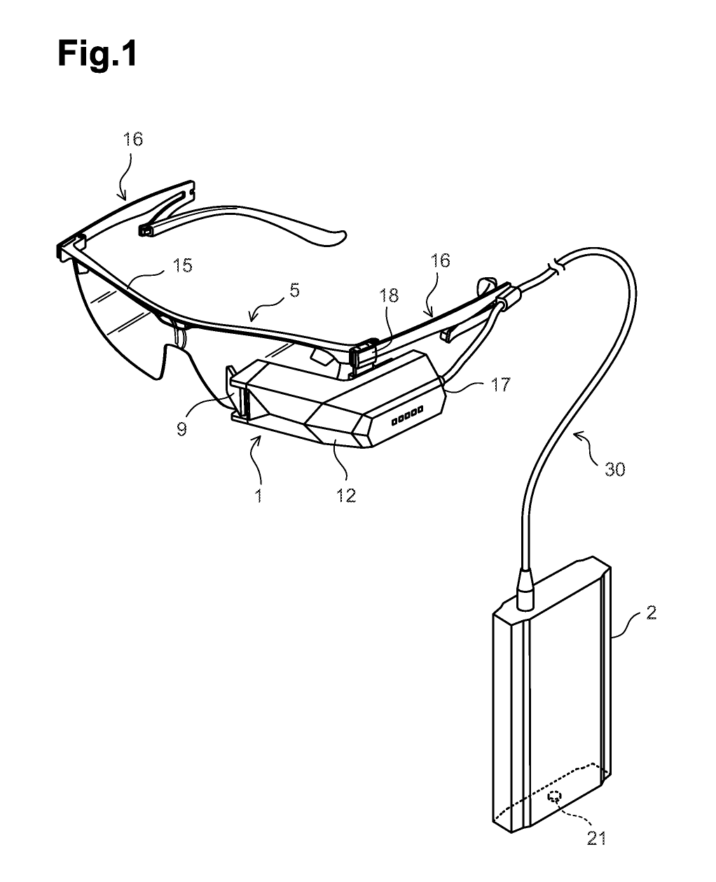

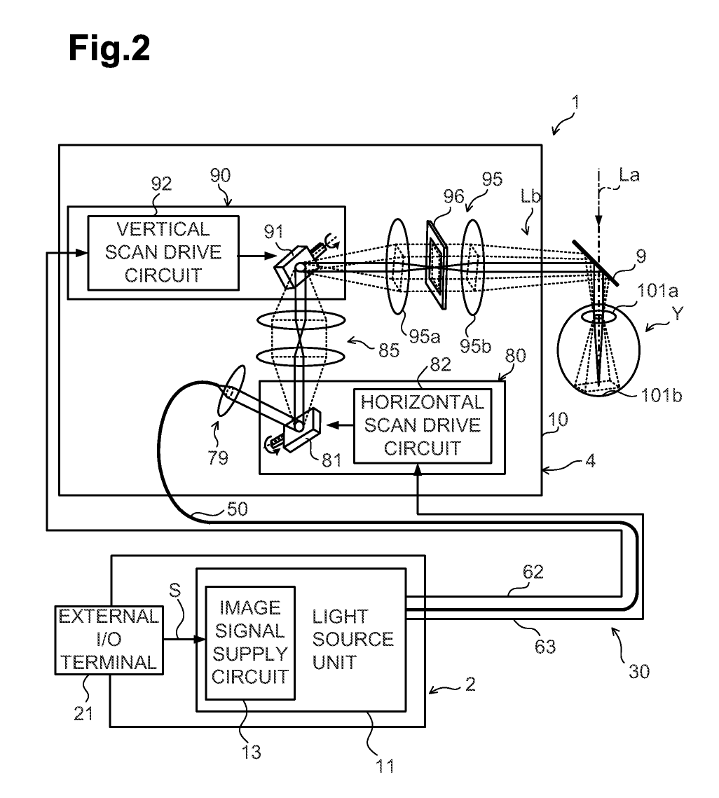

First, the configuration of the RSD according to this embodiment is described with reference to FIGS. 1 and 2. (Configuration of External Appearance of RSD)

As illustrated in FIG. 1, the RSD includes a control unit 2, a transmission cable 30, a display unit 1, and a spectacle-type frame 5. The control unit 2 emits a image light with intensity corresponding to an image signal. The transmission cable 30 includes an optical fiber 50 (see FIG. 2) for transmitting the image light emitted from the control unit 2. The display unit 1 scans the transmitted image light and projects the scanned image light to an eye 101 (see FIG. 2) of the user. The spectacle-type frame 5 serves to mount and hold the display unit 1 onto the head of the user through an attachment 18.

The control unit 2 is transportable in a state put in, e.g., a pocket of clothes of the user. An external input/output terminal 21 (see FIG. 2) is disposed at a bottom surface of the control unit 2. An external image signal is input to the control unit 2 through the external input/output terminal 21. The control unit 2 transmits and receives, e.g., content information, which is used to form the image data, to and from a personal computer (not shown), etc. through the external input/output terminal 21. Further, the control unit 2 forms the image signal based on the received content information and then emits the image light, which has intensity corresponding to the image signal, to the optical fiber 50 in the transmission cable 30. Be it noted that a content memory, for example, may be disposed in the control unit 2. In such a case, the image signal is formed based on the content information stored in the content memory. The term “content information” used herein means information made of at least one of data for displaying characters, data for displaying images, and data for displaying moving pictures. The content information is given in the form of, for example, a document file, an image file, or a moving picture file, which are used in the personal computer, etc.

The spectacle-type frame 5 is can be mounted to the head similarly to a pair of general spectacles. By mounting the spectacle-type frame 5 to the head, a half mirror 9 (described later) disposed at a distal end of the display unit 1 can be easily arranged in front of the user's eye.

Further, the spectacle-type frame 5 includes a front portion 15 and two temple portions 16 and 16 on the right and left sides. Each temple portion 16 has a such suspension structure that its intermediate part is formed into a Z-shape not only in a plan view, but also in a side view, thus allowing the temple portion to flex in a larger amount.

The display unit 1 is mounted to the left side (as viewed from the user) of the spectacle-type frame 5 having the above-described construction. In the display unit 1, an optical unit 4 (see FIG. 2) including a built-in projector 10 is disposed within a casing 12 that has an L-shape in a plan view. One end of the optical fiber 50 is connected to a proximal end 17 of the casing 12.

The projector 10 disposed in the optical unit 4 causes a image light Lb, which is obtained by two-dimensionally scanning the image light having the intensity modulated for each color (R, G or B), to enter the eye 101 (see FIG. 2) of the user, such that the image light Lb is two-dimensionally scanned over the retina of the user's eye 101 (see FIG. 2). The user visually recognizes an image corresponding to an image signal S with the image light scanned over the retina.

The half mirror 9 is disposed at the distal end of the casing 12 to be positioned in front of the eye 101 of the user. More specifically, as illustrated in FIG. 2, an outside light La passes through the half mirror 9 and enters the eye 101 of the user. On the other hand, the image light Lb emitted from the projector 10 is reflected by the half mirror 9 and then enters the eye 101 of the user. Therefore, the user visually recognizes the image formed by the image light Lb in a superimposed relation to an exterior sight provided by the outside light La.

Thus, the RSD according to this embodiment is a see-through type RSD in which the image light Lb with intensity corresponding to the image signal S is projected to the eye 101 of the user while the outside light La also enters the eye 101 in a passing-through way. However, the RSD is not always required to be the see-through type when the present invention is put into practice.

### Electrical Configuration and Optical Configuration of RSD

The electrical configuration and the optical configuration of the RSD will be described below. As illustrated in FIG. 2, the RSD is mainly constituted by the control unit 2 and the display unit 1 including the half mirror 9.

The light source unit 11, described in detail later, is disposed within the control unit 2. The light source unit 11 includes an image signal supply circuit 13. The image signal supply circuit 13 reads image information pixel by pixel from the image signal S, which is supplied through the external input/output terminal 21. Further, the image signal supply circuit 13 generates a laser beam of which intensity is modulated for each of R (red), G (green), and B (blue) in accordance with the image information that has been read pixel by pixel, and then emits the modulated laser beam to the optical fiber 50.

In the RSD according to this embodiment, as described above, the light source unit 11 is included in the control unit 2 such that the display unit 1 and the light source unit 11 are separately constituted. Accordingly, the size of the display unit 1 mounted to the head can be reduced. However, the light source unit 11 is not always required to be disposed in the control unit 2 and it may be disposed in the optical unit 4.

The projector 10 is disposed in the display unit 1. The projector 10 includes a collimator optical system 79, a horizontal scanner 80, a first relay optical system 85, a vertical scanner 90, and a second relay optical system 95.

The laser beam, emitted from the control unit 2, is two-dimensionally scanned by the horizontal scanner 80 and the vertical scanner 90. The horizontal scanner 80 includes a resonance-type deflector 81 having a deflecting surface, and a horizontal scan drive circuit 82 for generating, in accordance with a horizontal drive signal 61, a drive signal to resonate the deflector 81, to thereby oscillate the deflecting surface of the deflector 81. Further, the vertical scanner 90 includes a deflector 91 having a deflecting surface, and a vertical scan drive circuit 92 for generating, in accordance with a vertical drive signal 62, a drive signal to forcibly oscillate the deflecting surface of the deflector 91 in a not-resonated state. In the following description, the horizontal scanner 80 and the vertical scanner 90 are also collectively referred to as a “scanner”. For example, a galvanometer can be used as each of the deflectors 81 and 91. It is noted that any types of optical scanners, e.g, a MEMS mirror scanner driven by a piezoelectric drive, electromagnetic drive, or an electrostatic drive, a polygon mirror scanner, may be alternatively used for the deflectors 81 and 91. The deflector 81 may be non-resonance-type deflector. In this embodiment, the two-dimensional scanning is achieved by the horizontal scanner 80 and the vertical scanner 90, which are separated with each other. However, the horizontal scanner 80 and the vertical scanner 90 may be integrally disposed. That is, one two-dimensional scanner may be alternatively used instead of two separated one-dimensional scanners.

In the display unit 1 constituted as described above, the laser beam emitted from the control unit 2 through the optical fiber 50 is converted to a parallel beam by the collimator optical system 79 and is guided to the horizontal scanner 80. The parallel laser beam is reciprocally scanned in the horizontal direction by the deflecting surface of the deflector 81 so as to display an image. The horizontally scanned laser beam is converged by the first relay optical system 85 onto the deflecting surface of the deflector 91 of the vertical scanner 90. The laser beam having entered the vertical scanner 90 from the first relay optical system 85 is scanned in the vertical direction by the deflecting surface of the deflector 91. The laser beam two-dimensionally scanned by the horizontal scanner 80 and the vertical scanner 90, as described above, passes through the second relay optical system 95 including two lenses 95a and 95b, each of which has a positive refractive power and which are arranged in series. Further, the two-dimensionally scanned laser beam is reflected by the half mirror 9 that is positioned in front of the eye 101, and then enters the pupil 101a of the user. As a result, the laser beam is scanned over the retina 101b, whereby a display image corresponding to the image signal S is projected to the retina 101b. Thus, the user visually recognizes the laser beam Lb as the display image.

In the second relay optical system 95, respective rays of the scanned laser beam corresponding to individual pixels are converted by the lens 95a to become substantially parallel to each other at their center lines and to become converged laser beams. The individual laser beams converted by the lens 95a are further converted by the lens 95b to become substantially parallel laser beams and to be converged at their center lines onto the pupil 101a of the user. The lens 95b and the half mirror 9 functions as a projector for causing the laser beam Lb scanned by the scanner to enter the eye 101 of the user and projecting the image corresponding to the image signal S to the retina 101b of the user.

A mask 96 in the form of a frame is disposed at or near the position of an image plane (hereinafter referred to as an “intermediate image plane”) formed between the lens 95a and the lens 95b. The mask 96 is constituted by a light shield plate for preventing the laser beam, which is scanned outside an effective scan range, from entering the lens 95b. The mask 96 has an opening formed at its center such that the laser beam scanned inside the effective scan range can pass through the mask 96.

### Electrical Configuration and Optical Configuration of Light Source Unit 11

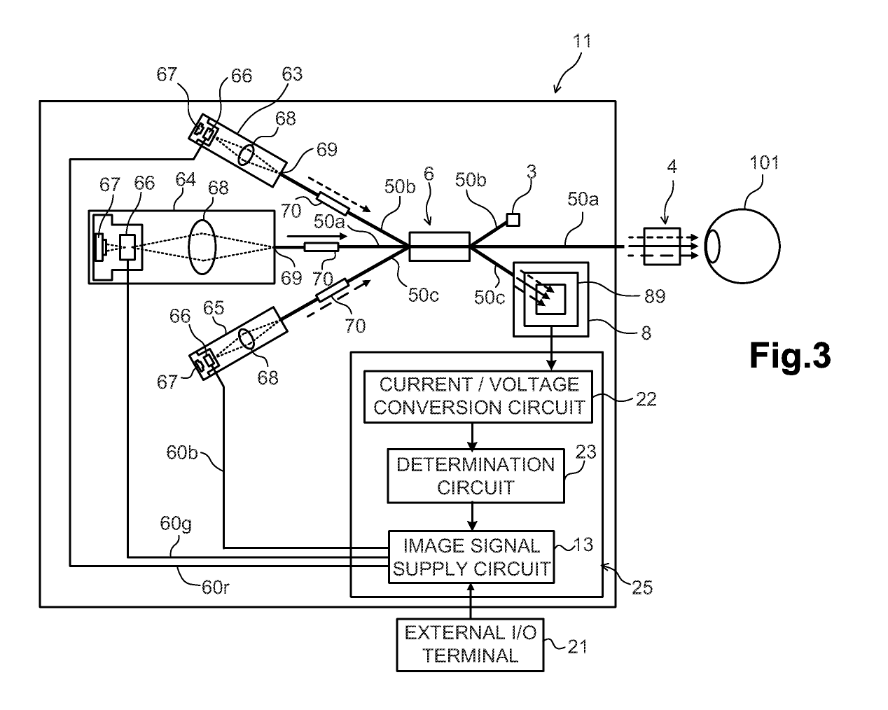

The light source unit 11 will be described in more detail below with reference to FIG. 3.

As illustrated in FIG. 3, the light source unit 11 includes an R (red) laser light source 63 serving as a first light source, a G (green) laser light source 64 serving as a second light source, and a B (blue) laser light source 65 serving as a third light source. The laser light sources 63, 64 and 65 are each made of a semiconductor diode (laser diode) (hereinafter abbreviated to an “LD”) constituted in the form of a pigtail module. In this embodiment, the laser light sources 63, 64 and 65 are used as an example of light sources because they are advantageous from the viewpoint of optical efficiency. But the light sources are not limited to the laser sources. Any types of light sources, e.g., LEDs (light emitting diodes), HID (high intensity discharge) lamps, OELs (organic electroluminescent), CFLs (cathode fluorescent lamp), may be alternatively available.

Further, in each of the R laser light source 63, the G laser light source 64, and the B laser light source 65, a laser device 66 and a first photodiode 67, which serves as a laser beam sensing means (laser beam sensor), are disposed in a state facing to each other. The first photodiode 67 can detect the intensity of a laser beam emitted from each of the R laser light source 63, the G laser light source 64, and the B laser light source 65. A lens 68 condenses the laser beam emitted from the laser device 66.

In addition, as illustrated in FIG. 3, three light sources (i.e., the R laser light source 63, the G laser light source 64, and the B laser light source 65) each in the form of a pigtail module are connected respectively to optical fibers 50b, 50a and 50c through their connecting portions 69. More specifically, the R laser light source 63 is connected to one end of the optical fiber 50b through the connecting portion 69, the G laser light source 64 is connected to one end of the optical fiber 50a through the connecting portion 69, and the B laser light source 65 is connected to one end of the optical fiber 50c through the connecting portion 69. Further, the optical fibers 50b, 50a and 50c are each spliced midway in its length through a splicing portion 70.

Further, an optical coupler 6 in which intermediate portions of the three optical fibers 50b, 50a and 50c are joined together by the melt-drawing method. The optical coupler 6 functions as an optical multiplexer module. Stated another way, the optical coupler 6 multiplexes the laser beams (RGB) of different wavelengths, which are input from the one end of each of the three optical fibers 50, and then outputs the multiplexed laser beams, i.e., a resulting multiplex laser beam, to the projector 10.

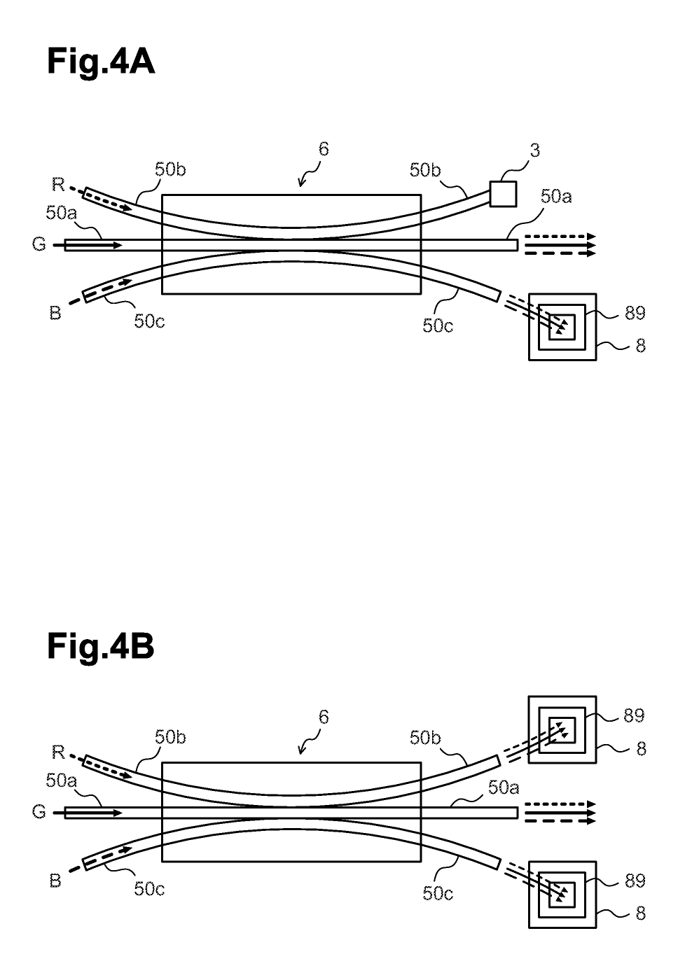

More specifically, as illustrated in FIG. 4A, the optical coupler 6 is formed by melt-drawing the three optical fibers 50b, 50a and 50c to be joined together while locally heating their intermediate portions to high temperature. The optical coupler 6 functions as an optical multiplexer module capable of multiplexing RGB lights. In general, as an optical fiber curves to a larger extent, light is more apt to leak. In the optical coupler 6 in this embodiment, therefore, the multiplex laser beam is taken out from the first optical fiber 50a, which is linearly extended at a center and which outputs the multiplex laser beam in a maximum light intensity.

Meanwhile, as illustrated in FIG. 2, the light source unit 11 outputs the horizontal drive signal 61 used in the horizontal scanner 80 and the vertical drive signal 62 used in the vertical scanner 90. The horizontal scanner 80 and the vertical scanner 90 are synchronized with the light source unit 11 by using the horizontal drive signal 61 and the vertical drive signal 62, respectively. The horizontal drive signal 61 and the vertical drive signal 62 are generated by the image signal supply circuit 13 and are transmitted from the image signal supply circuit 13 through a drive signal transmission cable (not shown) that is contained in the transmission cable 30 together with the optical fibers 50.

Further, the image signal supply circuit 13 includes an R laser driver, a G laser deriver, and a B laser driver for outputting LD drive currents that are used to drive the R laser light source 63, the G laser light source 64, and the B laser light source 65, respectively. The image signal supply circuit 13 generates an R image signal, a G image signal, and a B image signal in accordance with the image signal S. The R laser driver, the G laser deriver, and the B laser driver output the LD drive currents in accordance with the R image signal, the G image signal, and the B image signal, respectively. As a result, the laser beams having intensities modulated corresponding to the image signal S are emitted from the R laser light source 63, the G laser light source 64, and the B laser light source 65.

With the feature specific to this embodiment, the above-described light source unit 11 is further constituted to be able to detect, by a light sensor 8, a part of the multiplex laser beam emitted from the other end of either one (50c in FIG. 4A) of the optical fibers 50b and 50c except the first optical fiber 50a, which outputs a main part of the multiplex laser beam, among the three optical fibers 50b, 50a and 50c extending from the optical coupler 6 with their one ends being start points. Further, a determination circuit 23 is disposed as a control means for controlling an output of the light source unit 11 in accordance with the result of the above-described detection of a part of the multiplex laser beam. Alternatively, the laser beam may be output from the optical fiber 50b instead of the optical fiber 50c, and the light sensor 8 may be disposed to detect the multiplex laser beam emitted from the optical fiber 50b. However, it is desirable to detect the part of the multiplex laser beam emitted from the other end of the optical fiber that outputs the multiplex laser beam in a larger light intensity. The reason is that a second photodiode 89 (described below) is required to have higher accuracy of light receiving sensitivity as the light intensity of the output multiplex laser beam decreases.

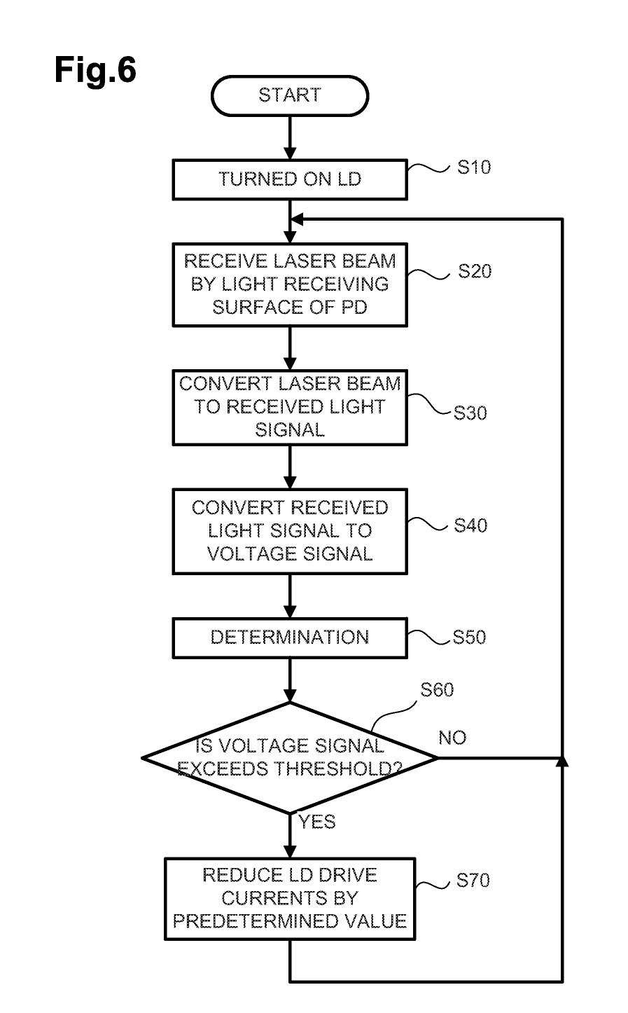

The second photodiode 89 is disposed in the light sensor 8. The result detected by the second photodiode 89 is used by the determination circuit 23 to determine whether the light intensity is abnormal or not. In accordance with the determination result, outputs of the three light sources, i.e., the R laser light source 63, the G laser light source 64, and the B laser light source 65 are controlled. Stated another way, the outputs of the R laser light source 63, the G laser light source 64, and the B laser light source 65 are controlled by utilizing weak light emitted from the optical fiber (i.e., the optical fiber 50b or 50c other than the optical fiber 50a in this embodiment), which has not been utilized in the past. A process of such output control will be described later with reference to FIG. 6.

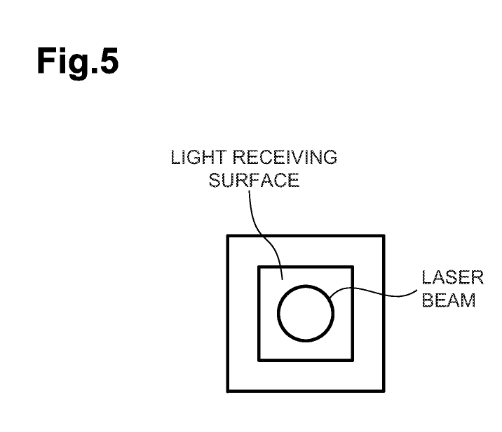

In view of that the laser beam emerges with a diverging cone angle, the second photodiode 89 is arranged, as illustrated in FIG. 5, such that even when the relative positional relationship between the optical fiber 50 and a light receiving surface of the second photodiode 89 varies, the whole of the laser beam enters the light receiving surface. The above-described relative positional relationship varies due to variations in, e.g., the angle of the end surface of the optical fiber 50, the diverging cone angle of the laser beam, the distance between the end surface of the optical fiber 50 and the light receiving surface of the second photodiode 89, and the size of the light receiving surface of the second photodiode 89.

The laser beams entering the one end of each of the optical fibers 50b, 50a and 50c from the R laser light source 63, the G laser light source 64, and the B laser light source 65 emit as the multiplex laser beam from each of the other ends (output ports) of the optical fibers 50b, 50a and 50c after being branched at predetermined rates. The red (R) laser beam, the green (G) laser beam, and the blue (B) laser beam emit such that the multiplex laser beam emits from the first optical fiber 50a at the branch rate of, e.g., about 60%, and emit from each of the optical fiber 50b and 50c at the branch rate of, e.g., about 20%.

In this embodiment, as illustrated in FIG. 4A, the first optical fiber 50a, which is linearly arranged at a center and which outputs the multiplex laser beam in a maximum light intensity, is connected to the projector 10. Further, the light sensor 8 is disposed near the terminating end of the optical fiber 50c, which outputs the multiplex laser beam in a larger light intensity, between the remaining optical fibers 50b and 50c. A terminator 3 is disposed at the other end of the optical fiber 50b which outputs the multiplex laser beam in a minimum light intensity.

As illustrated in FIG. 3, the determination circuit 23 is provided in the light source unit 11 and is disposed on an LD drive board 25 on which is also disposed the image signal supply circuit 13 for generating, e.g., signals serving as elements to synthetically form an image.

The determination circuit 23 includes a CPU, a ROM for storing data, e.g., a threshold used as a reference to determine the abnormal intensity of light, a working RAM, etc. Further, a current/voltage conversion circuit 22 for converting a detected current, which is output from the second photodiode 89 depending on the intensity of the light incident upon the light receiving surface thereof, to a voltage signal is also disposed on the LD drive board 25. Alternatively or in addition, the determination circuit 23 may include a hardware circuit where instructions are instantiated in the circuit (for example, in a field programmable gate array—FPGA) as compared to only a CPU.

### 2. Practical Operation of RSD

As described above, the external input/output terminal 21 (see FIGS. 1 and 2) is connected to the image signal supply circuit 13. When the image signal S is sent from, e.g., an external unit (not shown) connected to the light source unit 11 through the external input/output terminal 21, the image signal supply circuit 13 generates the signals, which serve as elements to synthetically form an image, pixel by pixel in accordance with the image signal S. Thus, as illustrated in FIG. 3, an R (red) image signal 60r, a G (green) image signal 60g, and a B (blue) image signal 60b are output from the image signal supply circuit 13.

Upon receiving the image signals 60r, 60g and 60b, the R laser light source 63, the G laser light source 64, and the B laser light source 65 emit respectively red, green and blue laser beams having intensities modulated corresponding to the received signals, and the emitted laser beams enter the one end of each of the optical fibers 50b, 50a and 50c.

As described above, those three laser beams are multiplexed by the optical coupler 6, which function as the optical multiplexer module, and are output as the multiplex laser beam to the projector 10 through the first optical fiber 50a. The multiplex laser beam is scanned by the scanners (i.e., the horizontal scanner 80 and the vertical scanner 90) and is projected to the eye 101 of the user. As a result, the user visually recognizes the desired image.

In the RSD according to this embodiment, the intensity of the multiplex laser beam emitted from the other end of the optical fiber 50 other than the first optical fiber 50a is detected, and the output of the light source unit 11 is controlled in accordance with the detection result. Stated another way, the determination circuit 23 in the RSD according to this embodiment serves as the control means to control the outputs of the R laser light source 63, the G laser light source 64, and the B laser light source 65 in accordance with the sum of respective quantities of the red, green and blue lights, which are detected by the light sensor 8. More specifically, the light sensor 8 detects the multiplex laser beams, including the red, green and blue lights, which are emitted from the other end of the optical fiber 50 other than the first optical fiber 50a. The determination circuit 23 controls the outputs of the R laser light source 63, the G laser light source 64, and the B laser light source 65 in accordance with the light intensity of the multiplex laser beam, including the red, green and blue lights, which has been detected by the light sensor 8. Thus, in the RSD according to this embodiment, the output of the light source unit 11 can be controlled by utilizing the light emitted from the optical fiber 50 that has been terminated in the past. As a result, the abnormal intensity of the emitted light can be detected while suppressing an increase in power consumption, heat generation, and the number of parts.

The output control of the R laser light source 63, the G laser light source 64, and the B laser light source 65 will be described below with reference to FIG. 6.

As illustrated in FIG. 6, when power supplies of the R laser light source 63, the G laser light source 64, and the B laser light source 65, each being made of the semiconductor laser (LD), are turned on in step S10, the laser light sources 63, 64 and 65 start operations to emit the laser beams.

In step S20, a part of the emergent light (multiplex laser beam) from the optical coupler 6 enters the light receiving surface of the second photodiode 89 in the light sensor 8 (see FIG. 5). In step S30, the multiplex laser beam having entered the light receiving surface of the second photodiode 89 is converted to a received light signal, i.e., an electrical signal corresponding to the light intensity of the received multiplex laser beam. In step S40, the received light signal is converted by the current/voltage conversion circuit 22 to a voltage signal at a level that is sufficient for the determination circuit 23 to make the determination. The level of the converted voltage signal is then determined (step S50).

In step S60, the CPU in the determination circuit 23 compares the voltage signal from the current/voltage conversion circuit 22 with the threshold stored in the ROM and determines whether there is an abnormality of the light intensity, e.g., whether the light intensity is excessively increased.

If the detection result (voltage signal) exceeds the threshold, the CPU executes control to reduce the LD drive currents, which are supplied from the image signal supply circuit 13, by a predetermined value in step S70. More specifically, the CPU reduces the LD drive signals by relatively reducing the R (red) image signal 60r, the G (green) image signal 60g, and the B (blue) image signal 60b, which are supplied from the image signal supply circuit 13 corresponding to the image signal S. The image signal supply circuit 13 stores a conversion table representing the correlation between brightness and a signal level for each of R (red), G (green), and B (blue). The image signal supply circuit 13 generates, based on the conversion table, the R image signal 60r, the G image signal 60g, and the B image signal 60b corresponding to the image signal S. When a request is issued from the CPU in the determination circuit 23, the image signal supply circuit 13 generates and outputs the R image signal 60r, the G image signal 60g, and the B image signal 60b each having a signal level that has been reduced at a reduction rate corresponding to the request. As a matter of course, if the voltage signal as the detection result does not exceed the threshold, the LD drive signals are not required to be particularly controlled.

By setting, in step S70, a reduction extent (i.e., the above-mentioned predetermined value) for the LD drive currents to be smaller if the detection result (voltage signal) exceeds the threshold, it is possible to control not only the abnormality of the light intensity, but also the operations of the light sources in a normal mode. Further, if the detection result (voltage signal) exceeds the threshold, the CPU may execute control to stop the emission of the laser beams from the light sources in consideration of safety. Alternatively, the threshold may be set to a smaller value from in consideration of safety.

Thus, the ROM in this embodiment stores the threshold for a maximum value of the multiplex laser beam emitted from the first optical fiber 50a, i.e., a maximum value of the light emitted from the light source unit 11. The CPU controls the output of the light emitted from each light source (i.e., each of the R laser light source 63, the G laser light source 64, and the B laser light source 65). Since a light intensity ratio is held constant among the multiplex laser beams emitted from the three optical fibers 50b, 50a and 50c as described above, the light intensity of the multiplex laser beam emitted from the first optical fiber 50a can be calculated based on the result detected by the light sensor 8.

The threshold for the maximum value of the multiplex laser beam emitted from the first optical fiber 50a can be decided in consideration of related factors, such as the transmittance of the laser beam(s) passing through the first optical fiber 50a, the transmittance of the laser beam(s) passing through another optical fiber 50c, the sensitivity characteristic of the second photodiode 89 per wavelength, and safety standards specified in the country where the RSD is to be used.

Since the second photodiode 89 is, as described above, disposed in an optical path downstream of the optical coupler 6 serving as the optical multiplexer module, the abnormality of the light intensity can be reliably detected even when the abnormality is caused by other variation factors than each laser device 66. More specifically, even when the abnormality of the light intensity is caused due to, for example, the pigtail coupling efficiency in the connecting portion 69 or the coupling efficiency in the slicing portion 70, the abnormality can be reliably detected. In addition, the abnormality of the light intensity caused by a failure of the second photodiode 89 itself can also be detected.

In the embodiment described above, as illustrated in FIG. 4A, the terminator 3 is disposed at the other end of one optical fiber 50b other than the first optical fiber 50a. As illustrated in FIG. 4B, however, the arrangement may be modified so as to detect both of the multiplex laser beams emitted from the other ends of the two optical fibers 50b and 50c other than the first optical fiber 50a.

With the modified arrangement, for example, even when the intensity of the received light does not reach a level required to execute the determination by using a single optical fiber, the determination can be performed by summing the quantities of lights emitted from plural optical fibers, and hence more accurate determination can be expected. In such a case, the light sensor 8 may be disposed in association with each of the optical fibers 50b and 50c. However, it is preferable to receive, by the single light receiving surface, the multiplex laser beams emitted from the other ends of the two (plural) optical fibers 50b and 50c other than the first optical fiber 50a. Stated another way, in a preferable arrangement, the two optical fibers 50b and 50c other than the first optical fiber 50a are bundled, for example, such that optical axes of the two optical fibers 50b and 50c are oriented in the same direction, and that the light sensor 8 including the photodiode is disposed at a position on extensions of those optical axes.

The threshold stored in the ROM may be set corresponding to a maximum value of the light intensity of the laser beam emitted from each light source (i.e., each of the R laser light source 63, the G laser light source 64, and the B laser light source 65). In other words, the CPU may control the outputs of each light source (i.e., each of the R laser light source 63, the G laser light source 64, and the B laser light source 65) such that the result detected by the light sensor for each light source (i.e., each of the R laser light source 63, the G laser light source 64, and the B laser light source 65) does not exceed the threshold corresponding to each light source. As a result, it is possible to execute not only the control adapted for detecting the abnormality of the light intensity, but also the control of operations of the light sources in a normal mode.

In order to detect respective light quantities of the laser beams emitted from the R laser light source 63, the G laser light source 64, and the B laser light source 65, the laser beams in R (red), G (green) and B (blue) having predetermined intensity (hereinafter referred to as “inspection laser beams”) are preferably emitted in sequence per frame. In that case, the inspection laser beams are emitted when a scan range of the scanner is positioned outside the effective scan range defined by the light-shield mask 96, i.e., when the scan range is positioned in the ineffective scan range. As the inspection laser beams, for example, the red laser beam is emitted in the first frame, the green laser beam is emitted in the second frame, and the blue laser beam is emitted in the third frame. A value obtained by detecting the light intensity of the emitted laser beam for each color is compared with the corresponding threshold. Further, the outputs of the R laser light source 63, the G laser light source 64, and the B laser light source 65 are controlled such that a total of the detection values for the laser beams in the three colors do not exceed a predetermined reference value.

Instead of emitting the inspection laser beams in R (red), G (green) and B (blue) in sequence per frame, the inspection laser beams in R (red), G (green) and B (blue) may be emitted in sequence line by line within one frame. This enables the inspection laser beams in the three colors to be emitted within each frame. As a result, the abnormality of the light intensity can be detected with respect to the R laser light source 63, the G laser light source 64, and the B laser light source 65 for each frame, whereby accuracy in detecting the abnormality of the light intensity can be improved.

### 3. Another Embodiment of RSD

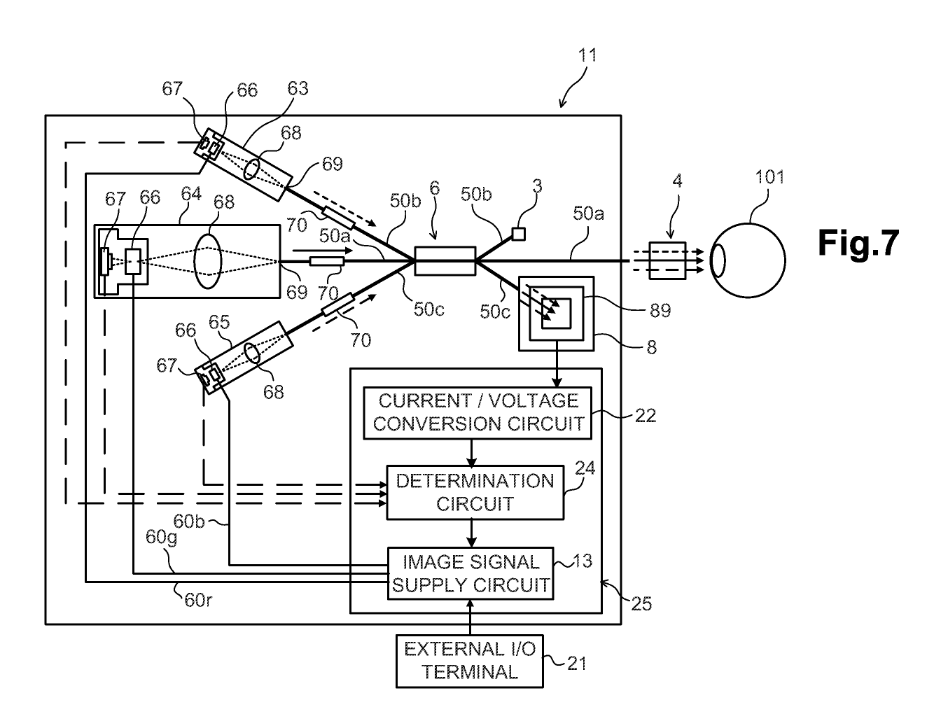

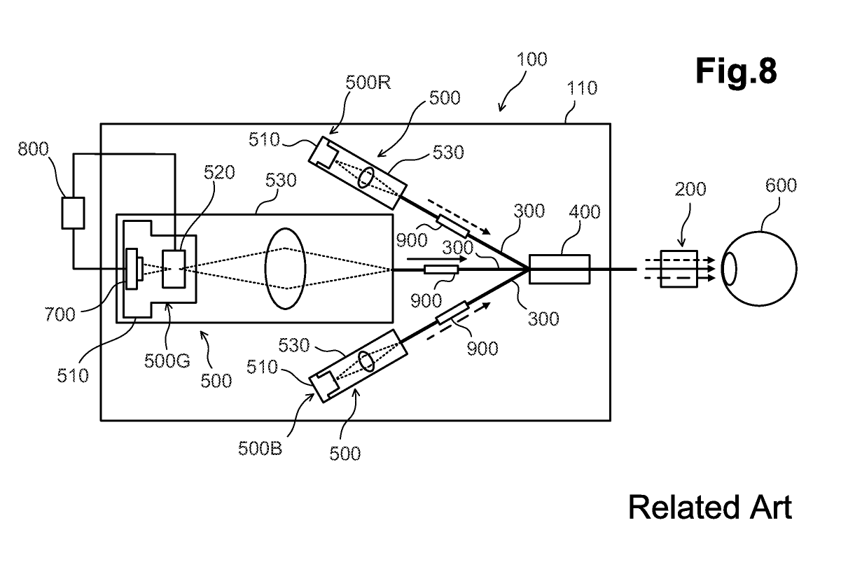

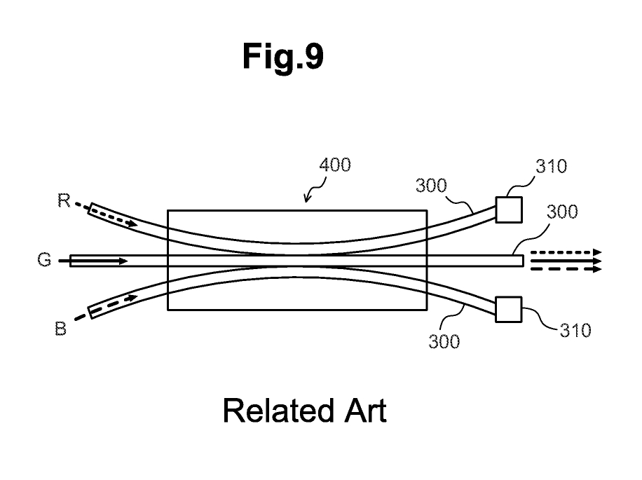

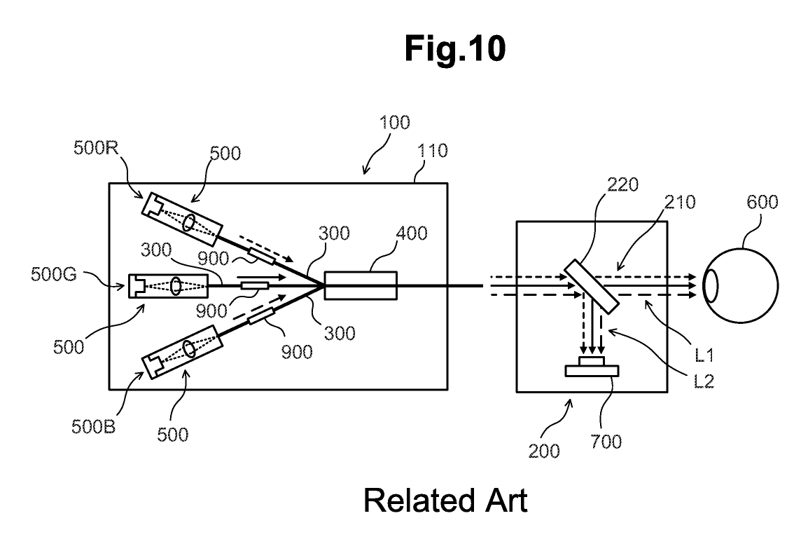

An RSD according to another embodiment will be described below with reference to FIG. 7. The configuration of the RSD according to another embodiment is substantially similar to that of the RSD illustrated in FIG. 3. In the foregoing embodiment, the CPU in the determination circuit 23 just executes the determination as to whether there is an abnormality of the light intensity or not, and the control to reduce the LD drive currents supplied from the image signal supply circuit 13 if there is an abnormality.

In contrast, in this embodiment, a determination circuit 24 disposed on the LD drive board 25 is designed to be able to receive a detection signal from the first photodiode 67, which is disposed as the laser beam sensing means in each of the R laser light source 63, the G laser light source 64, and the B laser light source 65.

With such an arrangement, the determination circuit 24 can control the outputs of the R laser light source 63, the G laser light source 64, and the B laser light source 65 based on one or both of the result detected by the second photodiode 89 in the light sensor 8 and the result detected by the first photodiode 67. Accordingly, even if either one photodiode 89 (or 67) has failed, the abnormality of the light intensity can be continuously detected.

In view of that the laser device 66 in each of the R laser light source 63, the G laser light source 64, and the B laser light source 65 has variations in characteristics, the R image signal 60r, the G image signal 60g, and the B image signal 60b can also be adjusted based on the results detected by the respective first photodiodes 67. Such an adjustment can be executed by modifying the above-described conversion table. The image signal supply circuit 13 outputs the R image signal 60r, the G image signal 60g, and the B image signal 60b corresponding to the image signal S after the adjustment. Further, the image signal supply circuit 13 may adjust the R image signal 60r, the G image signal 60g, and the B image signal 60b based on the result detected by the second photodiode 89 in the light sensor 8.

The following light source unit and RSD can be realized with the above-described embodiments.

The light source unit including the optical coupler 6 and the light sources (e.g., the R laser light source 63, the G laser light source 64, and the B laser light source 65) is realized. The optical coupler 6 is formed by joining the intermediate portions of the plural optical fibers 50 together. The lights having entered the one end of each of the optical fibers 50 are multiplexed in the optical coupler 6 where the intermediate portions of the plural optical fibers 50 are joined together. The light sources emit the lights of different wavelengths (e.g., the red light, the green light, and the blue light) so as to enter the one end of each of the plural optical fibers 50. The multiplex light emitted from an output end that is provided by the other end of one (e.g., the first optical fiber 50a) among the plural optical fibers 50. The light source unit includes a light sensing means (e.g., the light sensor 8). The light sensing means detects the multiplex light emitted from the other end of the optical fiber 50 other than the first optical fiber 50a. A control means (e.g., the determination circuit 23) controls the outputs of the light sources in accordance with the result detected by the light sensing means. With the light source unit thus constituted, the abnormality of the light intensity can be detected without causing a loss of the light intensity. Further, it is possible to detect abnormalities of the light intensity, which are caused by variation factors other than the light sources, (e.g., abnormalities of the light intensity attributable to the pigtail coupling efficiency in the connecting portion 69 of each optical fiber and the coupling efficiency in the slicing portion 70 of each optical fiber 50). Accordingly, the abnormality of the intensity of the emerging light can be detected while suppressing the power consumption and the heat generation. In addition, since the light sources emit three lights of different wavelengths, the light source unit can output light in the desired color, for example.

The light source unit 11 may further include the control means (e.g., the determination circuit 23). The light sensing means (e.g., the light sensor 8) may detect the light emitted from the other end of the optical fiber 50, which outputs the light in a maximum intensity from the other end thereof, among the plural optical fibers 50 except the above-mentioned one optical fiber (e.g., the first optical fiber 50a). With the light source unit thus constituted, a reduction of the accuracy in detecting the abnormality of the light intensity can be prevented even when a single light sensing means is provided.

Further, the light sensing means (e.g., the light sensor 8) may detect each of the lights emitted from the respective other ends of the plural optical fibers 50 other than the above-mentioned one optical fiber (e.g., the first optical fiber 50a).

With the light source unit thus constituted, light intensity sufficient for the detection can be reliably obtained and the accuracy in detecting the abnormality of the light intensity can be increased.

Still further, the light sensing means (e.g., the light sensor 8) may detect the lights emitted from the respective other ends of the plural optical fibers 50 other than the above-mentioned one optical fiber (e.g., the first optical fiber 50a) by a single light receiving surface. The light source unit thus constituted is more advantageous from the viewpoint of cost because the lights emitted from the other ends of each of the plural optical fibers 50 can be detected even with the provision of a single light sensing means.

The light sources may include a first light source (e.g., the R laser source 63) emitting a red light, a second light source (e.g., the G laser source 64) emitting a green light, and a third light source (e.g., the B laser source 65) emitting a blue light. The light sensing means (e.g., the light sensor 8) may detect, as the light emitted from the other end of the optical fiber 50, multiplex light including the red light, the green light, and the blue light. Further, the control means (e.g., the determination circuit 23) may controls the outputs of each of the first light source, the second light source, and the third light source in accordance with the intensity of the multiplex light, including the red light, the green light, and the blue light, which is detected by the light sensing means. With the light source unit thus constituted, the abnormality of the light intensity of the multiplex laser beam actually projected to the eye 101 of the user can be simply and reliably detected without detecting the intensity of each of the red light, the green light, and the blue light.

The light sources may include the first light source (e.g., the R laser source 63) emitting the red light, the second light source (e.g., the G laser source 64) emitting the green light, and the third light source (e.g., the B laser source 65) emitting the blue light. The control means (e.g., the determination circuit 23) may control the light sources to emit the red light, the green light, and the blue light from the first light source, the second light source, and the third light source at different timings, respectively. In that case, the light sensing means detects the red light, the green light, and the blue light at different timings Further, the control means may controls the outputs of each of the first light source, the second light source, and the third light source in accordance with the result detected by the light sensing means. With the light source unit thus constituted, respective quantities of the red light, the green light, and the blue light can be reliably detected.

The control means (e.g., the ROM in the determination circuit 23) may store a threshold for a maximum value of a intensity of the light emitted from each of the light sources (e.g., each of the R laser light source 63, the G laser light source 64, and the B laser light source 65). Further, the control means may controls the output of the light sources such that the result detected by the light sensing means (e.g., the light sensor 8) does not exceed the threshold for each of the light sources. With the light source unit thus constituted, the abnormality of the intensity of the light emitted from each of the plural light sources can be easily and promptly determined

The control means (e.g., the ROM in the determination circuit 23) may store a threshold for a maximum value of intensity of the lights emitted from the light sources (e.g., intensity of light resulting from multiplexing the lights emitted from the R laser light source 63, the G laser light source 64, and the B laser light source 65). Further, the control means may control the output of the light source such that the result detected by the light sensing means (e.g., the light sensor 8) does not exceed the threshold. With the light source unit thus constituted, the abnormality of the intensity of the lights emitted from the light sources can be easily and promptly determined

Each of the light sources may include a semiconductor laser (e.g., the R laser light source 63, the G laser light source 64, or the B laser light source 65) and a laser beam sensing means (e.g., the first photodiode 67) for detecting the intensity of a laser beam emitted from the semiconductor laser. Further, the control means (e.g., the determination circuit 24) may controls output of the semiconductor laser in accordance with one or both of the result detected by the light sensing means (e.g., the second photodiode 89 in the light sensor 8) and the result detected by the laser beam sensing means (e.g., the first photodiode 67). The control means thus constituted can detect the abnormality of the light intensity even when either one photodiode 89 (or 67) has failed.

The light sensing means may be a photodiode (e.g., the second photodiode 89), and the lights emitted from the other ends of the above-mentioned optical fibers 50 may be all able to enter a light receiving surface of the photodiode.

An optical scanning display is provided which includes the above-described light source unit, a scanner (e.g., a horizontal scanner 80 and a vertical scanner 90) for two-dimensionally scanning the lights emitted from the light source unit with intensities corresponding to an image signal, and a projector (including, e.g., the first relay optical system 85 and the second relay optical system 95 within the projector 10, as well as the half mirror 9) for projecting the lights scanned by the scanner to a projection target. Accordingly, the optical scanning display with very high safety can be provided.

A retinal scanning display (RSD) is provided which includes the above-described light source unit, a scanner (e.g., a horizontal scanner 80 and a vertical scanner 90) for two-dimensionally scanning the lights emitted from the light source unit with intensities corresponding to an image signal, and a projector (including, e.g., the first relay optical system 85 and the second relay optical system 95 within the projector 10, as well as the half mirror 9) for projecting the lights scanned by the scanner to an eye of a user. Accordingly, the retinal scanning display with very high safety can be provided.

While the embodiments of the present invention have been described in detail with reference to the drawings, those embodiments should be construed only as illustrations and the present invention can be practiced in other variously modified and improved forms on the basis of knowledge apparent to those skilled in the art.

For example, while the light source unit has been described as being applied to the optical scanning display (or the retinal scanning display), one or more aspects of the present invention are applicable to any type of display emitting a scanned light beam, e.g., a laser projector.

What is claimed is:

1. A light source unit comprising:
an optical coupler formed by joining intermediate portions of plural optical fibers together, and configured to multiplex lights, which enters one end of each of the optical fibers, in a coupling region where the intermediate portions of the optical fibers are joined together;
a light source configured to emit lights of different wavelengths, and located relative to the optical fibers to permit each of the lights to enter the one end of each of the plural optical fibers, respectively;
a light output portion located on the other end of one of the plural optical fibers and configured to output the multiplexed lights; and
a light sensor configured to detect light emitted from the other end of at least another one of the plural optical fibers.

2. The light source unit according to claim 1, further comprising a controller configured to control output of the light source in accordance with a result detected by the light sensor.

3. The light source unit according to claim 1, wherein the light sensor is configured to detects the light emitted from the other end of one of the other optical fibers, which outputs the light in a maximum light intensity from the other end thereof.

4. The light source unit according to claim 1, wherein the light sensor is configured to detect the light emitted from the other end of each of the other optical fibers.

5. The light source unit according to claim 5, wherein the light sensor is configured to detect the lights emitted from the other ends of the other optical fibers by a single light receiving surface.

6. The light source unit according to claim 1, wherein the light source is configured to emit three lights of different wavelengths.

7. The light source unit according to claim 6, wherein the light source comprises:
a first light source configured to emit a red light;
a second light source configured to emit a green light; and
a third light source configured to emit a blue light,
wherein the light sensor is configured to detect, as the light emitted from the other end of the optical fiber, multiplexed light including the red light, the green light, and the blue light.

8. The light source unit according to claim 7, further comprising:
a controller configured to control output of the light source in accordance with a result detected by the light sensor,
wherein the controller controls the output of the first light source, the second light source, and the third light source in accordance with an intensity of the multiplex light, including the red light, the green light, and the blue light, which is detected by the light sensor.

9. The light source unit according to claim 6, wherein the light source comprises:
a first light source configured to emit a red light,
a second light source configured to emit a green light, and
a third light source configured to emit a blue light,
wherein the light source is configured to emit the red light, the green light, and the blue light from the first light source, the second light source, and the third light source at different timings, and
wherein the light sensor is configured to detect the red light, the green light, and the blue light at different timings.

10. The light source unit according to claim 9, further comprising a controller configured to control output of the light source in accordance with a result detected by the light sensor,
wherein the controller is configured to control the output of the first light source, the second light source, and the third light source in accordance with a result detected by the light sensor.

11. The light source unit according to claim 2, wherein the controller is configured to store a threshold for a maximum value of intensity of the light emitted from the light source and control the output of the light source such that the result detected by the light sensor is maintained less than the threshold for each of the lights of different wavelengths.

12. The light source unit according to claim 2, wherein the controller is configured to store a threshold for a maximum value of intensity of the lights emitted from the light sources and control the output of the light source such that the result detected by the light sensor is maintained less than the threshold.

13. The light source unit according to claim 7, further comprising a controller controlling output of the light sources in accordance with a result detected by the light sensor,
wherein the light source further comprises:
a semiconductor laser; and
a laser beam sensor detecting intensity of a laser beam emitted from the semiconductor laser,
wherein the controller controls output of the semiconductor laser in accordance with at least one of the result detected by the light sensor and a result detected by the laser beam sensor.

14. The light source unit according to claim 1, wherein the light sensor is a photodiode, and
wherein the photodiode is configured to receive all the lights emitted from the other ends of the other optical fibers by a light receiving surface thereof.

15. An optical scanning display comprising:
the light source unit according to claim 1;
an optical scanner for two-dimensionally scanning the lights emitted from the light source unit with intensities corresponding to an image signal; and
a projector for projecting the lights scanned by the optical scanner to a projection target.

16. A retinal scanning display comprising:
the light source unit according to claim 1;
an optical scanner for two-dimensionally scanning the lights emitted from the light source unit with intensities corresponding to an image signal; and
a projector for projecting the lights scanned by the scanner to an eye of a user.

17. A light source unit comprising:
one or more light sources configured to produce lights of different wavelengths;
a plurality of optical fibers including at least a first optical fiber and a second optical fiber, such that an optical coupler exists at intermediate portions of the plurality of optical fibers, the optical fibers positioned relative to the one or more light sources to permit each of the lights to enter one end of each of the plurality of optical fibers, respectively, the first optical fiber configured to carry a first combination of the lights as combined by the optical coupler; and
a light sensor configured to detect a second combination of the lights as combined by the optical coupler emitted from the other end of the second optical fiber.

18. The light source unit according to claim 17, wherein the plurality of optical fibers further includes a third optical fiber.

19. The light source unit according to claim 18, wherein the other end of the third optical fiber is terminated.

20. The light source unit according to claim 18, wherein the light sensor is a first light sensor,
the light source unit further comprising a second light sensor connected to the other end of the third optical fiber.

21. The light source unit according to claim 17, wherein the optical coupler is a region of the optical fibers where the fibers are joined together.
